(19) United States
(12) Patent Application Publication
(10) Pub. No.: US 2011/0135794 A1
(43) Pub. Date: Jun. 9, 2011

(54) PROCESS FOR PRODUCING PRECISELY SHAPED GRAIN BASED PRODUCTS

(76) Inventors: Norbert Gimmler, Portage, MI (US); Charles Gambino, Little Rock, AR (US); Hillis Kauffman, Battle Creek, MI (US); Terry Engle, East Leroy, MI (US); Penny Engle, East Leroy, MI (US)

(21) Appl. No.: 12/963,124

(22) Filed: Dec. 8, 2010

Related U.S. Application Data
(60) Provisional application No. 61/267,625, filed on Dec. 8, 2009.

(51) Int. Cl. A21C 11/10; A23L 1/164; A23L 1/275; A23L 1/302; A23P 1/08; A23P 1/10; A21D 6/00; A21C 9/08

(52) U.S. Cl. 426/237; 426/503; 426/250; 426/289; 426/383; 426/275; 426/502; 426/285; 99/353; 99/345

(57) ABSTRACT

A cooking system includes a main wheel having a first surface and a secondary wheel having a second surface. The second surface of the secondary wheel mates with the first surface of the main wheel at a nip to form and set a grain based material disposed between the first and second surfaces. The grain based material may be dried, toasted, baked, puffed, or blistered between first and second surfaces. The method begins by disposing a cooked or uncooked grain based material over the first surface. The second surface, which corresponds to the first surface is applied to the grain based material at the nip to form and set the grain based material between the first and second surfaces. At least one of the first and second surfaces is heated to heat the grain based material disposed between the first and second surfaces to produce a ready-to-eat grain based product.

### CROSS REFERENCE TO RELATED APPLICATION

This application claims the benefit of U.S. Provisional Patent Application Ser. No. 61/267,625 for PROCESS FOR PRODUCING PRECISELY SHAPED GRAIN BASED PRODUCTS, filed on Dec. 8, 2009, which is hereby incorporated by reference in its entirety.

### BACKGROUND OF THE INVENTION

1. Field of the Invention

The subject invention relates to a cooking system for producing a ready-to-eat grain based product, more particularly to a method of producing a ready-to-eat grain based product.

2. Description of the Prior Art

Grains are typically transformed into edible products by cooking and subsequently transforming the cooked material into products having a particular shape and texture. These products require many steps and in most cases multiple pieces of equipment to produce the desired result. This is accomplished typically by first cooking, forming or shaping the grains and then running them along a conveyor through an oven. Multiple ovens may be necessary when multiple process steps, such as drying, toasting, baking and puffing are needed.

U.S. Pat. No. 6,153,243 to Rosso discloses a method of manufacturing a shaped wafer. A wafer mixture or wafer paste is disposed between a mating pair of mold halves. The mold is then heated to cook the wafer. The mold creates a sheet of cooked wafers that are separated by intermediate portions. The shaped wafers are then cut from the intermediate portions of the sheet. The intermediate portions result in a large amount of waste.

U.S. Pat. No. 3,024,112 to Burgess discloses a process for producing a biscuit. The biscuit is produced in a sheet that is heated and later broken in individual pieces. A roller is used to from a sheet of biscuits wherein the biscuits are interconnected by or separated from each other by a section of dough having a thickness less than the thickness of the biscuit. The sheeted biscuits are moved away from the roller along a conveyor to an oven where they are baked. After baking and cooling, the sheets are broken along the thinner sections that separate the biscuits.

U.S. Patent Publication No. 2002/0034573 to McNeel et al. discloses a method for making uniformly shaped snack food chips which can be stacked for packaging. A continuous sheet of dough is toasted then puffed before being cut into individual chip performs. The performs are then placed between two mold cavities where the performs are transported through hot oil to be cooked.

### SUMMARY OF THE INVENTION AND ADVANTAGES

The present invention relates to a ready-to-eat grain based product and method of producing the same. The grain based product may be cooked, toasted, baked, puffed, or blistered between first and second surfaces. The method begins by disposing a cooked or uncooked grain based material over the first surface. The second surface, which corresponds to the first surface is applied to the grain based material to form and set the grain based material between the first and second surfaces to produce the grain based product. At least one of the first and second surfaces is heated to cook, toast, bake, puff, or blister the grain based material disposed between the first and second surfaces to produce a ready-to-eat grain based product. The cooking system allows for the grain based material to be heated, that is cooked, backed, toasted, or blistered, simultaneously to being formed and set.

The present invention further relates to a cooking system for forming and setting the shape and piece size of the ready-to-eat grain based product. The cooking system includes a main wheel having a first outer face that defines a first surface and at least one secondary wheel having a second outer face that defines a second surface. The second outer face of the secondary wheel engages the first outer face of the main wheel at a nip to form and set a grain based material disposed between the first and second outer faces. Both the main and secondary wheels are rotatable to maintain the position of the first outer face relative to the second outer face. At least one feeder feeds a grain based material to at least one of the main wheel and the at least one secondary wheel. The grain based material is sandwiched between the main and secondary wheels at the nip as the main and secondary wheels rotate to move, form, set and heat the grain based material to produce a ready-to-eat grain based product. At least one of the main wheel and the at least one secondary wheel is heated to heat the grain based material sandwiched between the main wheel and the at least one secondary wheel.

In one embodiment of the invention, the main wheel and a secondary wheel are of equal size and their rotary axes are aligned horizontally. The grain based material, which can be a continuous sheet or a loose blend of individual grain particulates, is delivered into the nip between the two rotating wheels and a continuous sheet of grain based product is released on the underside of the nip. The continuous sheet of grain based product released from the nip between the wheels of the cooking system is cooked, puffed, blistered, toasted or baked, depending on the condition of the grain based material fed into the nip as well as the rotational speed of the two wheels, the surface of the two wheels, the gap between the wheels, and the temperature of the heated wheels.

In another alternative embodiment of the cooking system, the surface of one of the main or secondary wheels is equipped with cutting edges that emboss indentations into the surface of the continuous sheet as it is fowled in the nip between the two wheels. The continuous sheet is then pruned to break along the embossed indentations after it sets to a brittle state.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a simplified flow diagram illustrating the steps of an exemplary embodiment of the subject invention;

FIG. 2 is a flow chart showing a method of producing a ready-to-eat grain based product;

FIG. 3 is a perspective view of a cooking system according to the subject invention;

FIG. 4 is a side view of the cooking system according to FIG. 3 of the subject invention;

FIG. 5 is a perspective view of a cooking system according to the subject invention;

FIG. 6 is a side view of the cooking system according to FIG. 5 of the subject invention;

FIG. 7 is a perspective view of a cooking system according to the subject invention;

FIG. 8 is a side view of the cooking system according to FIG. 7 of the subject invention;

FIG. 9 is a side view of a cooking system according to the subject invention;

FIG. 10 is a perspective view of a cooking system according to the subject invention;

FIG. 11 is a partial perspective view of the cooking system showing the grain based material disposed between a main and secondary wheel;

FIG. 12 is a partial perspective view of the cooking system showing a distributing drum disposing a product additive to the grain based material and a secondary wheel for securing the product additive to the grain based material;

FIG. 13 is a partial perspective view of the cooking system showing a second feeder for feeding additional sheets of grain based material to the main wheel;

FIG. 14 is a partial perspective view of the cooking system showing the secondary wheel for securing the product additive to the grain based material;

FIG. 15 is perspective view of an exemplary grain based product;

FIG. 16 is perspective view of an exemplary grain based product;

FIG. 17 is perspective view of an exemplary grain based product;

FIG. 18 is cross-sectional view of the exemplary grain based product of FIG. 17;

FIG. 19 is a partial plan view of a block of grain based product according to the subject invention; and

FIG. 20 is a partial plan view of a block of grain based product according to the subject invention.

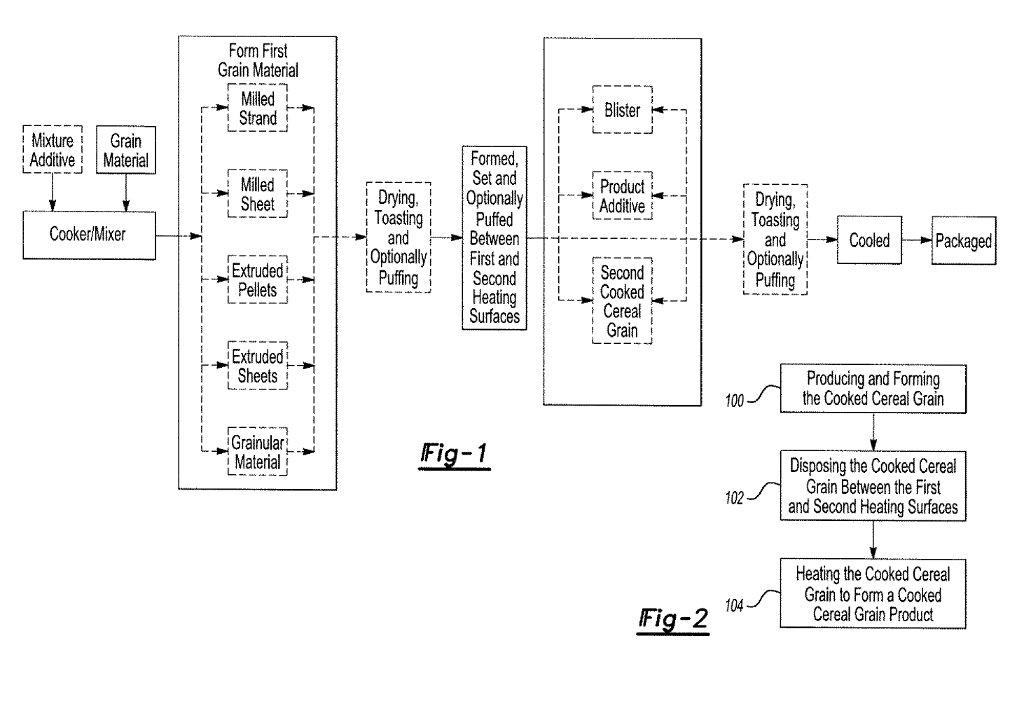

### DETAILED DESCRIPTION OF THE INVENTION

Referring to the Figures, wherein like numerals indicate corresponding parts throughout the several views, a cooking system 20 for producing a ready-to-eat grain based product 22 and method of making the same are general shown.

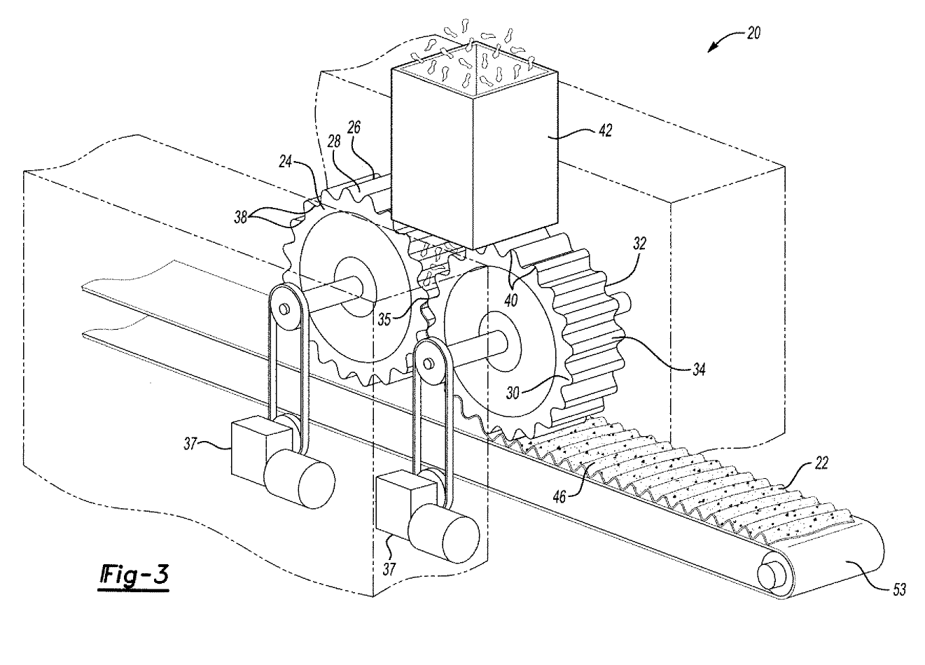

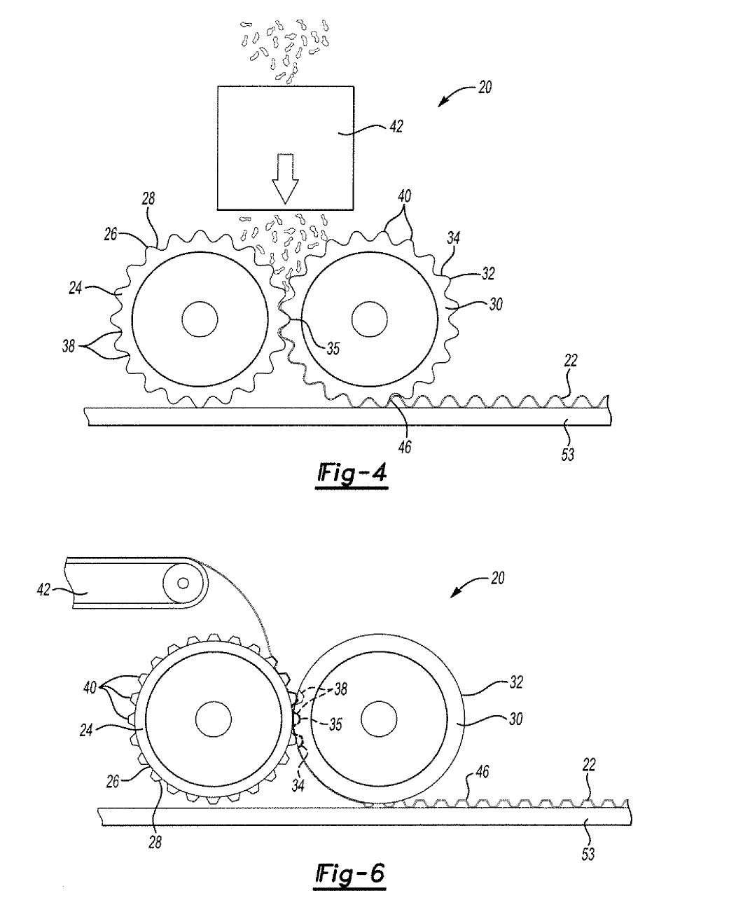

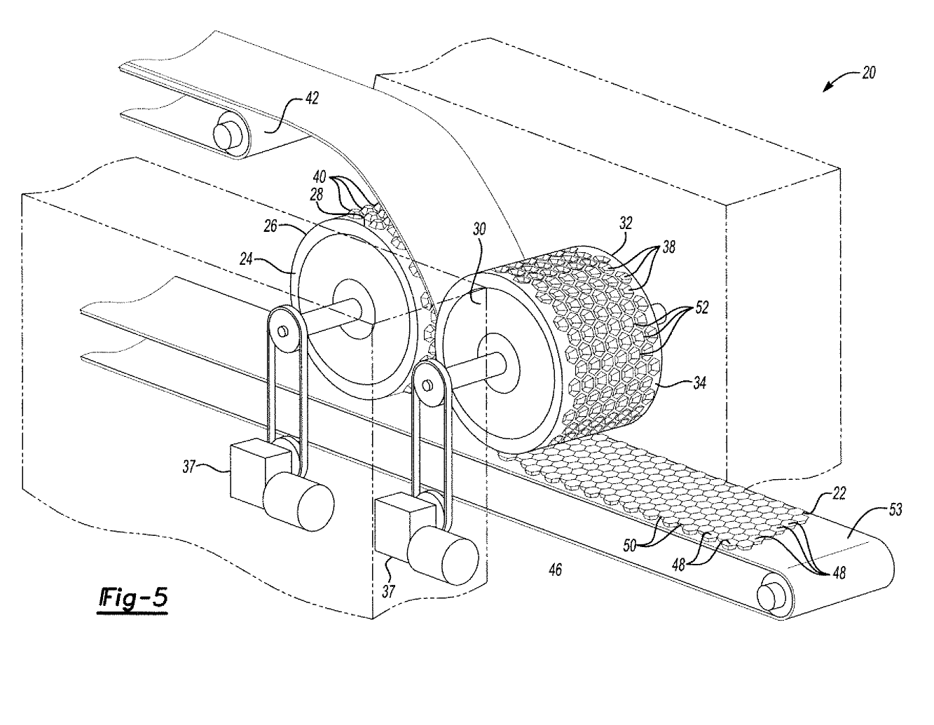

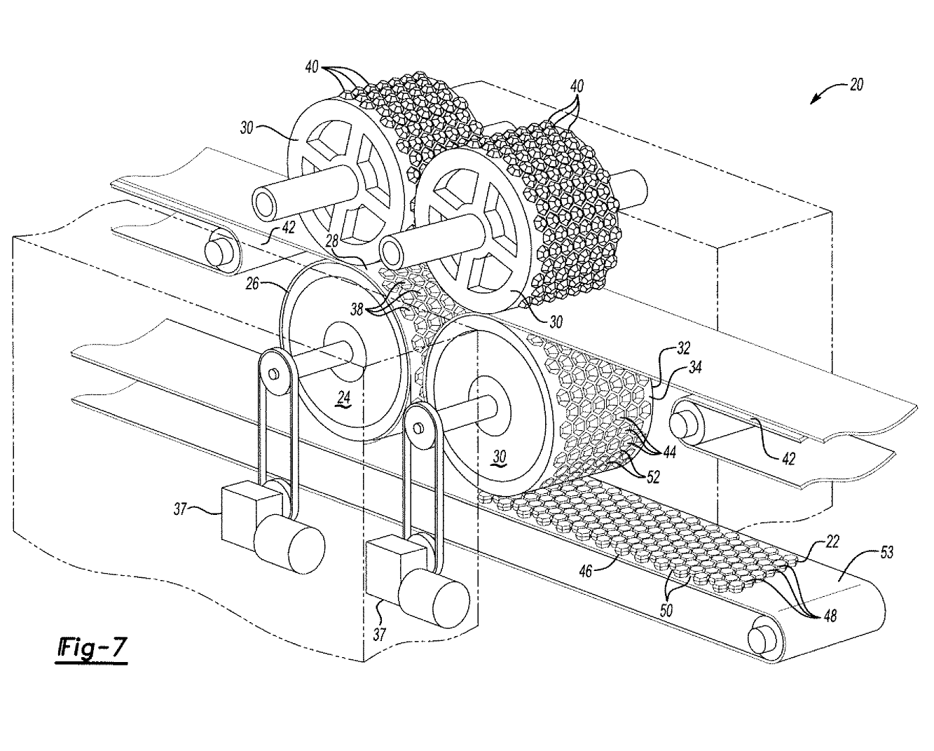

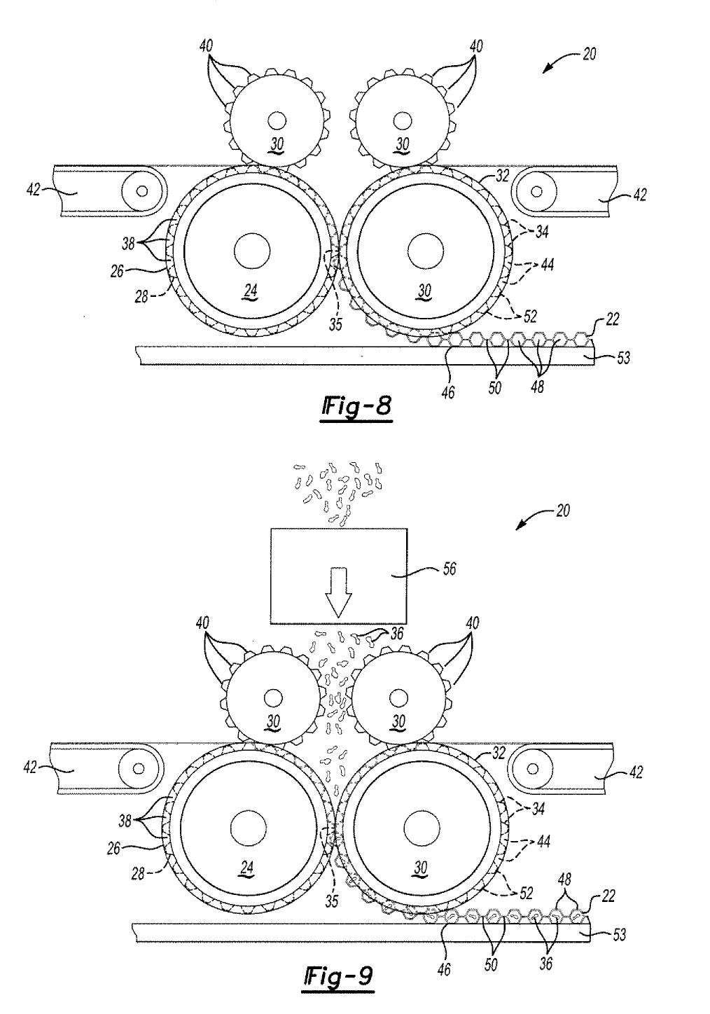

The cooking system 20 includes a main wheel 24 having a first outer face 26 that defines a first surface 28 and at least one secondary wheel 30 having a second outer face 32 that defines a second surface 34. In the exemplary embodiment, as seen in FIGS. 3-6, the cooking system 20 includes the main wheel 24 and only one secondary wheel 30. The main wheel 24 and the secondary wheel 30 are of equal size and their rotary axes are aligned horizontally. It should be appreciated that while the main and secondary wheels 24, 30 are of equal size and their rotary axes are aligned horizontally, they may be of varying sizes and have their rotary axes aligned at any angle. In addition, any number of secondary wheels 30 may be used, as seen in FIGS. 7-10 and 13. The grain based material, which can be a continuous sheet or a loose blend of individual grain particulates, is delivered to a nip 35 between the two rotating wheels 24, 30 and a continuous sheet of grain based product 22 is released on the underside of the nip 35. The nip 35 is the point, pinch or bite where the surfaces 28, 34 of the two wheels 24, 30 engage one another during rotation to squeeze or compress tightly the grain based material and form the continuous sheet of grain based product 22. The continuous sheet of grain based product 22 released from the nip 35 between the wheels 24, 30 of the cooking system 20 is cooked, puffed, blistered, toasted or baked, depending on the condition of the grain based material fed into the nip 35 as well as the rotational speed of the two wheels 24, 30, the surface of the two wheels 24, 30, the gap between the wheels 24, 30, and the temperature of the heated wheels 24, 30. The cooking system 20 allows for the grain based material to be heated, that is cooked, backed, toasted, or blistered, simultaneously to being formed and set.

The second outer face 32 of the secondary wheel 30 engages with the first outer face 26 of the main wheel 24 to form, set and heat the grain based material disposed between the first and second outer faces 26, 32. Both the main and secondary wheels 24, 30 are rotatable to maintain the position of the first outer face 26 to the second outer face 32. In the preferred embodiment, the wheels 24, 30 rotate in opposing direction to drive or move the grain based material to through the nip 35 and to the transfer device 53. At least one motor 37 is used to drive the wheels 24, 30. In one embodiment, each of the wheels 24, 30 may include a motor 37 or any other means known in the art for rotating a wheel. In an alternative embodiment, one motor 37 may be used to drive all the wheels 24, 30. This may be accomplished through the use of a motor 37 and gear set. The wheels 24, 30 may be made from aluminum, stainless steel or any other material known in the art.

The invention relates to a process for producing a precisely shaped grain based food product. The process includes the optional step 100 of producing of the grain based material prior to disposing the grain based material on one of the first and second surfaces 28, 34. An exemplary method for making the grain based material starts with the step of cooking grains in water. In the exemplary method, enough water is added to achieve a moisture content of about 26%-34% by weight and the grains are cooked. Cooking of a bulk of grain particulates or a dough of milled grain materials is well-known in the art and includes heating the grain in contact with water or water vapor. This technique is often termed “pre-cooking” in cereal chemistry.

The grains may be cooked in a rotary cooker. Additional methods of creating cooked grain particulates or cooked dough may be used. Such methods include, but are not limited to, extrusion cooking. With extrusion cooking at least one milled grain material is cooked with water to achieve a moisture content of about 15-34% by weight and make a cooked extrudate.

While the exemplary embodiment has discussed grain based materials that have been cooked, it should be appreciated that uncooked dough, for example, a cracker dough could be used as the grain based material. It should be further appreciated that the grain based material may be a combination of uncooked grains or cooked grain particulates with any sticky slurry binder, such as cooked oatmeal, known in the art. Instead of placing the grain material and mixture additive into a cooker, the grain material and mixture additive may be placed into a mixer.

The grain based material that is produced may be a grain mixture having at least one grain disposed therein. In the exemplary embodiment, the grain based material is a mixture of rice, cut wheat and liquid that is cooked in a rotary cooker to form the grain based material. Of course, other grains may be used in alternative embodiments of the invention, including but not limited to oats, wheat, rice, corn, barley and mixtures thereof, with rice and wheat being preferred. Further, the grains used are a parameter that must be considered when creating a puffed product.

The grain mixture may include a mixture additive that is disposed into the grain mixture. The mixture additive disposed into the grain mixture may be any additive known in the art including but not limited to, vitamins, flavoring agents, and heat sensitive edible ingredients. The mixture additive can be selected from any known additive known in the art of grains, although it is preferred that the mixture additive matter be compatible in taste with the grain component of the grain mixture. Examples of edible mixture additives useful in the present invention include, but are not limited to: granola, real and imitation fruit and fruit pieces, including dehydrated fruit, such as raisins, pieces of peaches, apples, pears, apricots, strawberries, blueberries, raspberries, bananas, real and imitation nuts and pieces of nuts such as almonds, peanuts, cashews, walnuts, whole, sliced and chopped pieces of raw and cooked grains and seeds such as oats, wheat, barley, corn, sunflower seeds, sesame seeds, vegetables and pieces of vegetable materials, wheat germ composite materials prepared from wheat germ and oil, sweeteners, such as sugars and artificial sweeteners, malt extract, and confectionery items, such as cookies, candies, and marshmallows. Granola, real fruit and fruit pieces, including dehydrated fruit and fruit pieces, whole raw oat particles are preferred for their flavor and nutritional properties. The vitamins, flavoring agents, and heat-sensitive edible ingredients can be selected from any known to those skilled in the art, although it is also preferred that the heat-sensitive edible ingredients be compatible in taste with the grain component of the flake. Examples of heat-sensitive edible ingredients useful in the present invention include, but are not limited to leavening agents, for example sodium aluminum phosphate, milk powder, dairy whey, gelatin, and mixtures thereof. Examples of flavoring agents and vitamins useful in the present invention include, but are not limited to, natural and artificial flavoring agents such as cinnamon, spice oleoresins, vanillin, benzaldehyde, and mixtures thereof, and especially heat sensitive flavoring agents such as vanilla, almond extract, citrus oils, and mixtures thereof, and vitamins such as riboflavin, folio acid, pyridoxine hydrochloride, and mixtures thereof, and especially heat-sensitive vitamins such as thiamin, ascorbic acid, cyanocobalamin, and mixtures thereof. For purposes of the present invention, the term “heat-sensitive edible ingredients” does not include heat-sensitive vitamins and heat-sensitive flavoring agents.

In an optional step, the cooled, moist grains may be dried to remove a portion of the moisture. An exemplary moisture level range of the cooled, moist grains is about 18-36%. However, this range can vary based on other process parameters. In an exemplary embodiment, the grain mixture is dried by convection with air, but drying can be achieved by a heated conveyor belt or by other suitable drying methods. At this time, the dried grains may be optionally cooled.

In the exemplary embodiment, the grain based material is at least one sheet of grain. The at least one sheet of grain is produced prior to the feeding the grain based material to the first or second surfaces 28, 34 of the wheels 24, 30. In an exemplary embodiment, the grains may be milled to form sheets of grain, but any method known in the art of forming sheets may be used to form the sheet of grain. The mills can be used to produce a mill pattern in at least one of the sheets of grain. Any mill pattern known in the art may be used. Thickness of the sheets is another parameter that must be considered when creating a puffed product. The thicker the sheet the more difficult puffing becomes.

A single sheet of grain based material may be placed between the first and second surfaces 28, 34 to produce the grain based product 22. In the exemplary embodiment, the at least one sheet of grain based material may be fed to the nip 35 between the main and secondary wheels 24, 30. The at least one sheet is fed from a feeder 42 and may be fed to either the first or second surfaces 28, 34 of the main or secondary wheels 24, 30 to guide the grain based product 22 to the nip 35. In an alternative embodiment, a plurality of sheets of grain based material may be fed to the first or second surfaces 28, 34. The sheets may be fed to the main or secondary wheels 24, 30 at any point along the main or secondary wheels 24, 30. In the exemplary embodiment, the at least one sheet is fed to one of the main or secondary wheels 24, 30 prior to the nip 35. When a plurality of sheets are disposed between the first and second surfaces 28, 34, a product additive 36 may be disposed between the plurality of sheets of grain based material. The product additive 36 may be any additive known in the art including, but not limited to nuts, fruit, edible particulates or any of the previously disclosed additives.

In an alternative embodiment, the grain based material may be a plurality of grain based strands. The strands may be formed from an extruder or by any other method known in the art. The plurality of strands of grain based material are then fed from the feeder 42 between the first and second surface 28, 34 at the nip 35 to create the continuous sheet of grain based product 22.

In an alternative embodiment, the grain based material may be a plurality of grain based pellets. The plurality of pellets may be formed from an extruder by cutting an extrudate of grain based material as it is extruded out of the extruder, cutting the strands of grain based material, or by any other method known in the art. The plurality of pellets of grain based material may be mixed with a cooked, starch-containing material to bond the plurality of pellets of grain based material together. In this embodiment, the cooked starch-containing material bonds the plurality of pellets of grain based material to form a mixture or slurry. The cooked starch may include any starch known in the art and examples of the starches used include, but are not limited to oatmeal. The plurality of pellets of grain based material are then fed from the feeder 42 between the first and second surface 28, 34 at the nip 35 to create the continuous sheet of grain based product 22. A plurality of feeders 42 may be used to feed different pellets of grain based material to the nip 35. The pellets may vary in shape, size, color and flavor to produce a product have a unique look or taste. The differing pellets may be fed from a single feeder 42 or a plurality of feeders 42, with each of the plurality of feeders 42 housing a differing type of pellet.

In step 102, the grain based material is fed between the a first and second surfaces 28, 34 of the main and secondary wheels 24, 30. The first surface 28 may be a flat surface, a plurality of first indentations 38, or a plurality of wavy or raised portions 40. The second surface 34 of the secondary wheel 30 may be a flat roller, a roller having a pattern of an exact negative image of the first indentations 38 on the first surface 28, or any other wheel or roller known in the art. The main and secondary wheels 24, 30 are used to form and set the grain based material between the first and second surfaces 28, 34. The second surface 34 of the secondary wheel 30 is applied to the grain based material to sandwich the grain based material between the first and second surfaces 28, 34. The second surface 34 corresponds to the first surface 28 at the nip 35 to form and set the grain based material. The surfaces 28, 34 of the main and secondary wheels 24, may be modified based on the desired shape of the final grain based product 22. Prior to the grain based material being fed to one of the main or secondary wheel 24, 30, the grain based material may be optionally conditioned. Conditioning includes drying, toasting or optionally puffing the grain based material.

In the exemplary embodiment, at least one feeder 42 feeds the grain based material to at least one of the main wheel 24 and the at least one secondary wheel 30. The feeder 42 may be any feeder 42 known in the art for feeding grain based material to a cooking system 20, including but not limited to, conveyors and hoppers. The grain based material fed may be in the form of sheets, pellets, strains or any other form known in the art. In one exemplary embodiment, a conveyor is used to feed a sheet of grain based material to the main wheel 24. A plurality of feeders 42 may be used to feed the grain based material to the nip 35. In one example, separate feeders 42 may be used to dispose a sheet of grain based material to both the main and secondary wheels 24, 30. An additional feeder 42 may be used to feed a plurality of grain based pellets to the nip 35. A plurality of feeders 42 may be used to feed different pellets of grain based material to the nip 35. The pellets may vary in shape, size, color and flavor to produce a product have a unique look or taste. The differing pellets may be fed from a single feeder 42 or a plurality of feeders 42, with each of the plurality of feeders 42 housing a differing type of pellet. Any number or type of feeders 42 may be used depending on the final product desired.

The grain based material is sandwiched between the main and secondary wheels 24, 30 as the main and secondary wheels 24, 30 rotate to move, form, set and heat the grain based material. Heating of the grain based material, can include, but is not limited to, baking, toasting, cooking, drying, puffing and blistering the grain based material. At least one of the main wheel 24 and the at least one secondary wheel 30 is heated to heat the grain based material sandwiched between the main wheel 24 and the at least one secondary wheel 30. Any number of wheels 24, 30 may heated, for example, one of the wheel 24, 30 may be heated, all of the wheels 24, 30 may be heated, or only selected wheels 24, 30 may be heated. In exemplary embodiment of FIG. 3, one or both of the main and secondary wheels 24, 30 may be heated. The wheels 24, may include a heater or any other means for heating a rotary wheel known in the art.

The system may include any number or combination of main and secondary wheels 24, 30. In the exemplary embodiment, as shown in FIGS. 3-6, the cooking system 20 includes a single secondary wheel 30 that engages the main wheel 24 to form, set and heat the grain based product 22. In an alternative embodiment, as shown in FIGS. 7-10 and 13, the system includes a single main wheel 24 having a plurality of secondary wheels 30 disposed there about. The secondary wheels 30 can be equal in size to the main wheel 24 or can vary in size relative to each other or the main wheel 24.

The cooking system 20 may include at least one feeder 42 or a plurality feeders 42. When multiple feeders 42 are required, the feeders 42 may be disposed at various positions along the main wheel 24. In the exemplary embodiment of FIG. 3, a single feeder 42 is used to feed the grain based material to the cooking system 20. The feeder 42 is disposed upstream of the nip 35 to feed the grain based material to the cooking system 20 prior to the location of the nip 35. In an alternative embodiment, the cooking system 20 includes a first feeder 42 for feeding a grain based material to the main wheel 24 and a second feeder 42 for feeding additional grain based material to the grain based material disposed on the main wheel 24.

A force may be applied to the grain based material that is disposed over at least one of the first and second surfaces 28, 34. This force conforms the grain based material to the first and second surfaces 28, 34. The force is applied by the one of the wheels 24, 30 in which the product is not disposed. The wheel 24, 30 applying the force may include a plurality of raised portions 40 that mate with the plurality of first and second indentations 38, 44 to conform the grain based material to the first and second surfaces 28, 34.

At least one of the first outer face 26 of the main wheel 24 and the second outer face 32 of the at least one secondary wheel 30 may be contoured. In the exemplary embodiment, the main wheel 24 includes a plurality of first indentations 38 that are embedded in the first outer face 26 and the secondary wheel 30 includes a plurality of second indentations 44 that are embedded in the second outer face 32. The plurality of second indentations 44 correspond to the plurality of first indentations 38 disposed on the main wheel 24. The plurality of second indentations 44 of the secondary wheel 30 are contoured in a pattern of an exact negative image of the plurality of first indentations 38 on the main wheel 24. As seen in FIGS. 7-9, the plurality of first indentations 38 on the main wheel 24 and the plurality of second indentations 44 on the at least one secondary wheel 30 engage during operation to create a ready-to-eat grain based product 22 having a pillow-shape. In this embodiment, a force may be required to conform the grain based material to the first and second surfaces 28, 34 prior to the grain based material being formed and set into a pillow-shape at the nip 35. As seen in FIGS. 7-9, additional secondary wheels 30 may be used to create the force to conform the grain based material to the first and second surfaces 28, 34. The additional secondary wheels 30 include a plurality of raised portions 40 that mate with the plurality of first and second indentations 38, 44 to conform the grain based material to the first and second surfaces 28, 34 prior to the grain based material being formed and set at the nip 35.

In an alternative embodiment, the secondary wheel 30 includes a plurality of raised portions 40 that extend from the second outer face 32. The plurality of raised portions 40 correspond to the plurality of first indentations 38 disposed on the main wheel 24. The plurality of first indentations 38 on the main wheel 24 and the plurality of raised portions 40 on the at least one secondary wheel 30 mate during operation to create a ready-to-eat grain based product 22 having a cup-shape. It should be appreciated that while the cooking system 20 of the exemplary embodiment of FIGS. 3-6 includes just one main wheel 24 and one secondary wheel 30, the cooking system 20 could comprise any number of combinations of main and secondary wheels 24, 30 having surfaces 28, 34 that are flat, include a plurality of indentations 38, 44, or a plurality of raised portions 40.

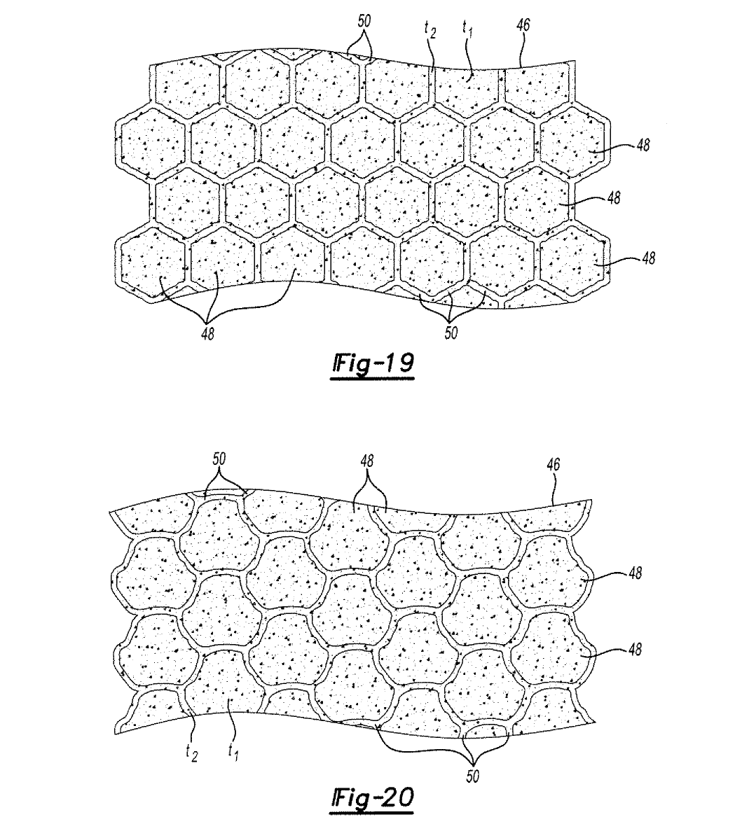

The second surface 34 and the first surface 28 are rotatably engaged to sandwich the grain based material between the first and second surfaces 28, 34 at the nip 35. The first and second surfaces 28, 34 thus form and set the grain based material into a block 46 or sheet as shown in FIGS. 19 and 20. The block 46 of ready-to-eat grain based product 22 defines a plurality of individual grain based pieces having a first thickness t₁ connected by intermediate portions 50 having a second thickness t₂ being less than the first thickness t₁. The first and second thicknesses t₁, t₂ correspond to the spacing between the first and second surfaces 28, 34. The lower second thickness t₂ is used later in production to break the sheeted cooked grain material into the individual food pieces.

The intermediate portions 50 are formed by a cutting pattern 52 formed on at least one of the first surface 28 of the main wheel 24 and the second surface 34 of the secondary wheel 30. The cutting pattern 52 applies the plurality of intermediate portions 50 to the grain based product 22 to allow for the grain based product 22 to be broken along the intermediate portions 50.

The grain based material disposed between the first and second surfaces 28, 34 is heated to produce the ready-to-eat grain based product 22 in step 104. At least one of the first and second surfaces 28, 34 are at a temperature from about 250-800° F. to bake, toast or puff the grain based material disposed therebetween. One of the main or secondary wheels 24, 30 may be heated or both may be heated. The temperature may be adjusted to any temperature known in the art based on the desired properties of the grain based product 22. Factors that affect the desired temperature include but are not limited to, the grain based material used, the amount of time heated, the desired texture of the final grain based product 22, the speed of the first and second surfaces 28, 34 and any other temperature facture known in the art of baking and toasting.

After the cooking system 20 has formed and set the grain based material at the nip 35 between the adjacent main and secondary wheel 24, 30, the block 46 of grain based material is fed along one of the main or secondary wheels 24, 30 to a transfer device 53 to move the grain based product 22 away from the wheels 24, 30 and potentially expose the grain based product 22 to further processing. In the exemplary embodiment, the transfer device 53 is a conveyor disposed below the cooking system 20 to receive the block 46 of grain based material from one of the wheels 24, 30.

After the block 46 is moved to the transfer device 53, it may be subject to further processing. A heat source, such as hot air from an air impingement device 54, may be applied to the block 46 of grain based material to modify the surface of the block 46 of grain based product 22. Such, modification of the surface of the grain based product 22 includes drying or blistering the surface, puffing the grain based product 22, or any other product modification known in the art. Additionally, a product additive 36 may be added to an outer surface of the block 46 of grain based product 22 after the heating step. The productive additive may be nuts, fruit, edible particulates or any other product additive 36 known in the art. A second secondary wheel 30 may be used to secure the product additive 36 to the pliable grain based product 22 by exerting a force onto the product additive 36 such that it will engage the pliable grain based product 22.

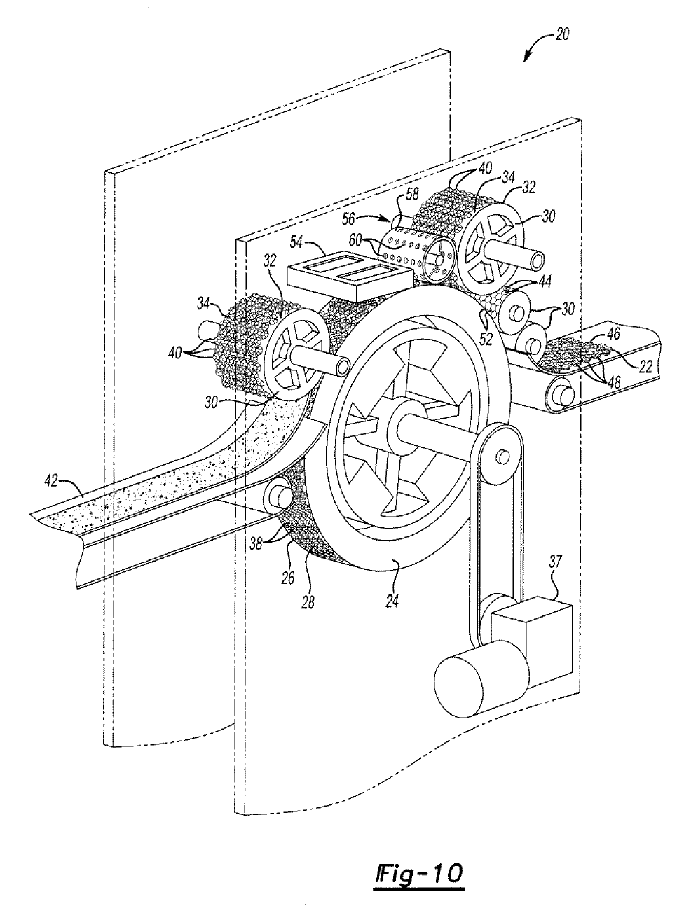

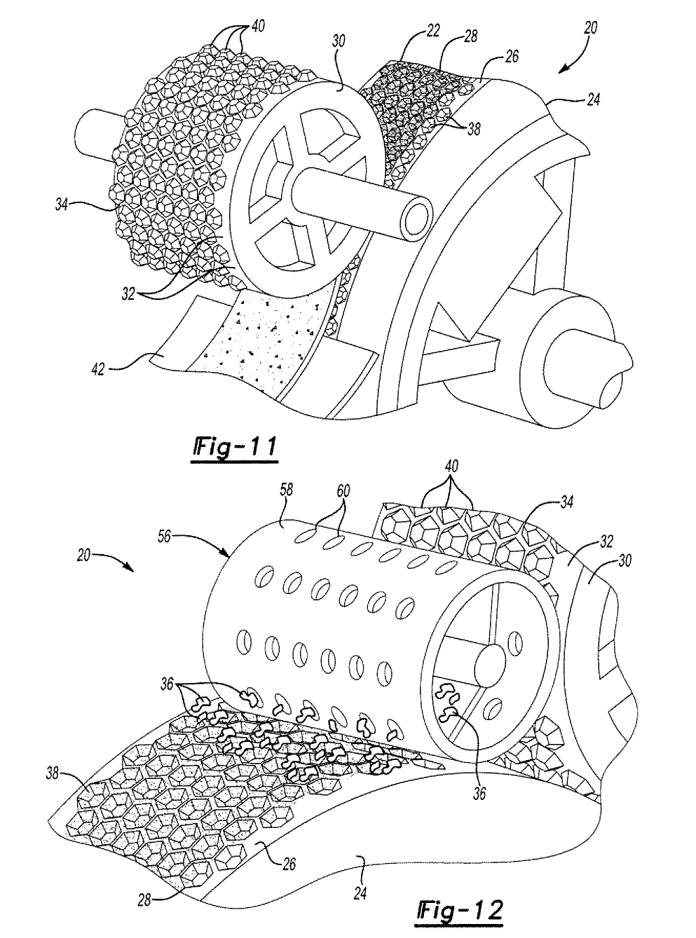

In an alternative embodiment, when a plurality of secondary wheels 30 are used, as in FIGS. 10 and 13, the grain based material may be exposed for further processing along the main wheel 24. In one exemplary embodiment, a heat source, such as hot air from an air impingement device 54, may be applied to the block 46 of grain based product 22 to modify the surface of the block 46 of grain based product 22. Such, modification of the surface of the grain based product 22 includes drying or blistering the surface, puffing the grain based product 22, or any other product modification known in the art. When blistering the surface of the block 46 of grain based product 22 the heat source may be a hot air impingement device 54, an infrared heater or any other heating device known in the art to blister or modify the surface of the block 46 of grain based product 22. The cooking system 20 may include a plurality of air impingement devices 54 disposed about the main wheel 24, part of a conveyor system prior to the main wheel 24 or part of a conveyor system after the main wheel 24.

A product additive 36 may be added to an outer surface of the block 46 of grain based product 22 after the heating step. The additive may be nuts, fruit, edible particulates or any other product known in the art. Immediately following the heating step, the grain based product 22 has a moisture content from about 4-25%, preferably 8-15%. At this moisture range, the grain based product 22 are still pliable and the productive additive may be applied to the grain based product 22 without the use of a tacking agent. A second secondary wheel 30 may be used to secure the product additive 36 to the pliable grain based product 22 by exerting a force onto the product additive 36 such that it will engage the pliable grain based product 22.

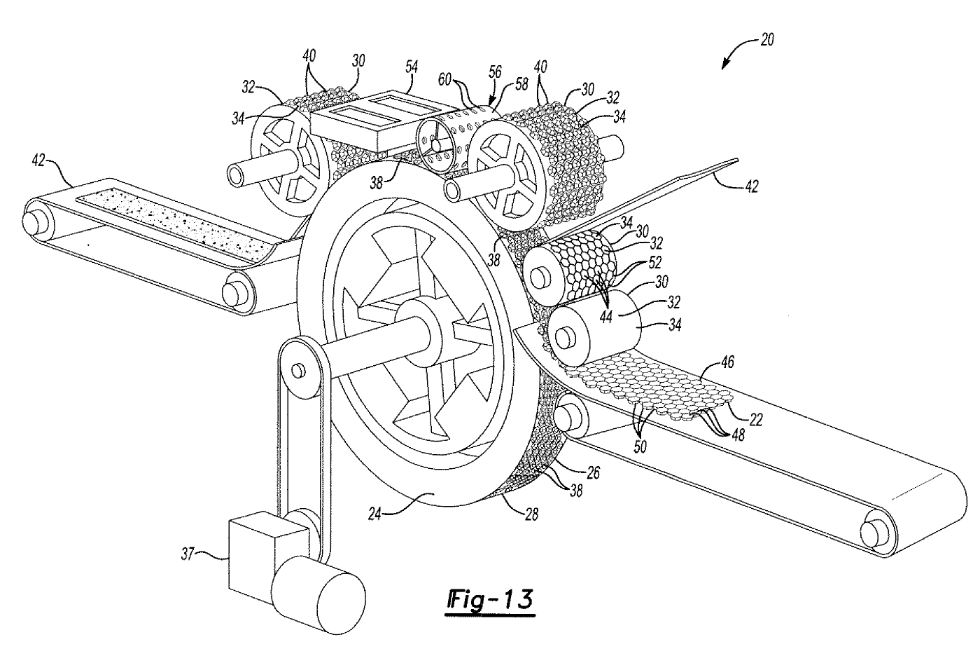

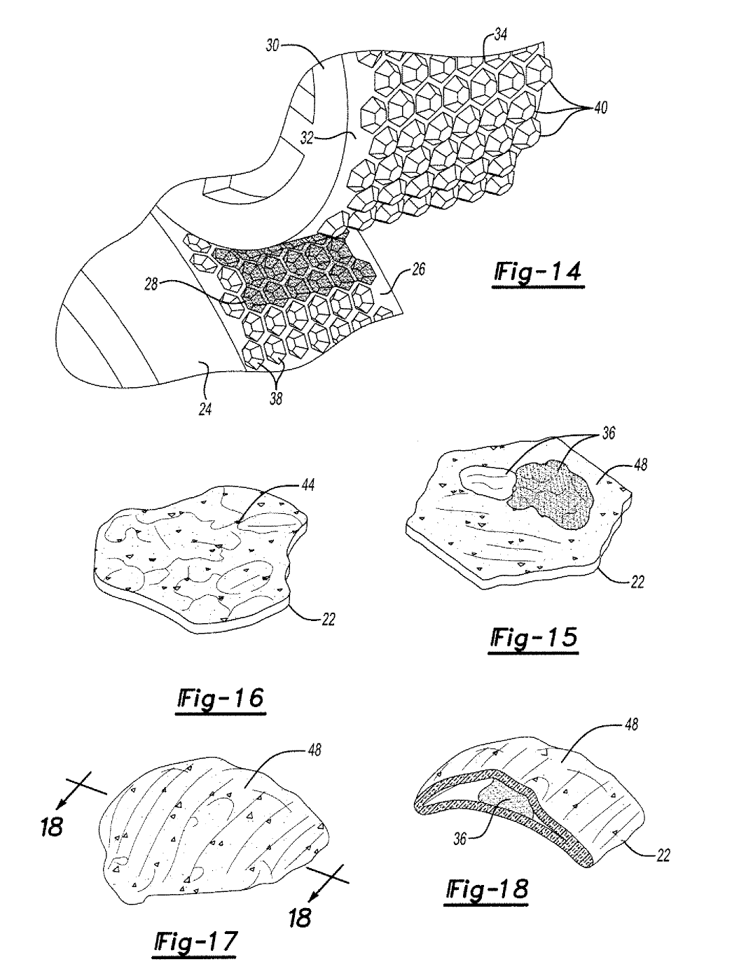

The cooking system 20 in the present invention may include a distributor 56 for distributing the product additive 36 onto the grain based material. The distributor 56 can be any means known in the art for applying product additive 36 to the grain based material. In the one embodiment, as shown in FIG. 12, the distributor 56 is a distributing drum 58 having a plurality of distributing openings 60 disposed therein. The distributing drum 58 may rotate relative to the main wheel 24 to distributing the product additive 36 on to the grain based material as the main wheel 24 moves the grain based material. A second secondary wheel 30 may be disposed adjacent the distributor 56 to secure the product additive 36 to the grain based material. The second secondary wheel 30, as seen in FIGS. 12 and 14, includes a plurality of raised portions 40 that extend from the second outer face 32 of the secondary wheel 30. The plurality of raised portions 40 correspond to the plurality of first indentions disposed on the main wheel 24 to apply a force to the product additive 36 disposed on the grain based material and secure the product additive 36 to the grain based material. The productive additive may be fed by a feeder 42 before or after the nip 35. In an alternative embodiment, the product additive 36 may be an edible marking that is applied to the grain based material by at least one of laser marking and ink jetting.

After the grain based product 22 has been cooked, baked, toasted, blistered or puffed, the grain based product 22 may be cooled. The cooled gain based product 22 may be broken into individual pieces of grain based product 22 along the intermediate portions 50 and packaged for shipping. In addition, the block 46 of grain based product 22 may be packaged for shipping and broken into individual pieces of grain based product 22 along the intermediate portions 50 by an end user.

Optionally, prior to packaging the grain based product 22, the grain based product 22 may be coated with a secondary product additive. In an exemplary embodiment, a coating operation may be used in applying the secondary product additive 36. A sprayer could be used to apply the secondary product additive 36 as the grain based product 22 moves along a conveyor belt. The secondary product additive may include, but is not limited to, frosting, vitamins, edible particulates, flavoring, artificial sweeteners, coloring or any additive previously disclosed. The addition of the secondary product additive may require a final drying step in order to dry the grain based product 22 prior to being packaged. The drying of the additive may be accomplished by a dryer, exposing the coated grain based product 22 to ambient air, or any other method of drying known in the art. In an alternative embodiment, the secondary product additive may be an edible marking that is applied to the grain based product 22 by laser marking, ink jetting or any other method known in the art.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

What is claimed is:

1. A method of producing a ready-to-eat grain based product comprising the steps of:
forming a nip between a first surface and a corresponding second surface disposed adjacent the first surface, wherein the first surface is defined by a first outer face of a main wheel, the second surface is defined by a second outer face of a secondary wheel, and each of the main and secondary wheels are rotatable;
feeding a grain based material to the nip;
moving the grain based material through the nip between the first and second surfaces to form and set the grain based material between the first and second surfaces; and
heating at least one of the first and second surfaces to heat the grain based material disposed between the first and second surfaces to produce a ready-to-eat grain based product.

2. The method as set forth in claim 1 wherein the moving step is further defined as rotating each of the main and secondary wheels to move the grain based material through the nip to form and set the grain base material between the first and second surfaces.

3. The method as set forth in claim 1 wherein the forming step is further defined as forming a nip between a first surface having a plurality of first indentations and a second surface having a plurality of second indentations corresponding to the plurality of first indentations disposed on the first surface to form and set the grain based material between the first and second surfaces.

4. The method as set forth in claim 3 further including the step of shaping the first and second surfaces to create a plurality of pillow-shaped cavities spaced by intermediate portions when the second surface is applied to the first surface at the nip.

5. The method as set forth in claim 3 further including the step of shaping the first and second surfaces to create a plurality of cup-shaped cavities spaced by intermediate portions when the second surface is applied to the first surface at the nip.

6. The method as set forth in claim 1 wherein the heating step is further defined as heating the grain based material disposed between the first and second surfaces to produce a block of ready-to-eat grain based product being defined by a plurality of individual grain based pieces having a first thickness connected by intermediate portions having a second thickness being less than the first thickness.

7. The method as set forth in claim 6 further comprising the step of breaking the block of grain based product into individual grain based pieces along the intermediate portions.

8. The method as set forth in claim 6 further comprising the step of applying a product additive to an outer surface of the block of grain based product after the heating step.

9. The method as set forth in claim 8 wherein the product additive is at least one of nuts, fruits, frosting, vitamins, edible particulates, flavorings, or coloring.

10. The method as set forth in claim 8 wherein the applying the product additive step is further defined as applying an edible marking to the block of grain based product by at least one of laser marking and ink jetting.

11. The method as set forth in claim 1 wherein the feeding step is further defined as feeding at least one sheet of grain based material on one of the first and second surfaces to be fed to the nip to font, and set the grain based material.

12. The method as set forth in claim 1 wherein the feeding step is further defined as feeding a plurality of sheets of grain based material on at least one of the first and second surfaces to be fed to the nip to form and set the grain based material.

13. The method as set forth in claim 12 wherein at least one of the plurality of sheets is disposed along the first surface and at least one of the plurality of sheets is disposed along the second surface.

14. The method as set forth in claim 12 further including the step of disposing a product additive between the plurality of sheets of grain based material.

15. The method as set forth in claim 14 wherein the product additive is at least one of nuts, fruit and edible particulates.

16. The method as set forth in claim 1 further including the step of producing a grain based mixture having at least one grain based material disposed therein.

17. The method as set forth in claim 1 further including the step of forming a sheet of grain based material prior to the feeding the grain based material to the nip step.

18. The method as set forth in claim 1 further including the step of forming a plurality of pellets of grain based material prior to the feeding the grain based material to the nip step.

19. The method as set forth in claim 18 further including the step of mixing the plurality of pellets of grain based material with a cooked starch-containing material to bond the plurality of pellets of grain based material.

20. The method as set forth in claim 1 further including the step of forming a plurality of strands of gain based material prior to the feeding the grain based material to the nip step.

21. A cooking system for cooking a ready-to-eat grain based product comprising:
a main wheel being rotatable and having a first outer face defining a first surface;
at least one secondary wheel being rotatable and having a second outer face defining a second surface for engaging said first outer face of said main wheel during rotation;
a nip formed where said main wheel and said at least one secondary wheel engage each other for forming and setting a grain based material;
at least one feeder for feeding the grain based material to at least one of said main wheel and said at least one secondary wheel to form and set the grain based material between said main and secondary wheels as said main and secondary wheels rotate to move the grain based material; and
a heater for heating at least one of said main wheel and said at least one secondary wheel, wherein at least one of said main wheel and said at least one secondary wheel is heated for heating the grain based material sandwiched between said main wheel and said at least one secondary wheel to produce the ready-to-eat grain based product.

22. The cooking system as set forth in claim 21 wherein said cooking system includes one secondary wheel.

23. The cooking system as set forth in claim 22 wherein said main wheel and said secondary wheel are the same size.

24. The cooking system as set forth in claim 22 wherein each of said main wheel and said secondary wheel are rotatable about an axis and each of the axis are aligned horizontally.

25. The cooking system as set forth in claim 21 wherein at least one of said first outer face of said main wheel and said second outer face of said at least one secondary wheel is contoured.

26. The cooking system as set forth in claim 21 wherein said main wheel includes a plurality of first indentations embedded in said first outer face.

27. The cooking system as set forth in claim 26 wherein said secondary wheel includes a plurality of second indentations embedded in said second outer face, said plurality of second indentations corresponding to said plurality of first indentations disposed on said main wheel.

28. The cooking system as set forth in claim 27 wherein said plurality of second indentations of said secondary wheel are contoured in a pattern of an exact negative image of said plurality of first indentations on said main wheel.

29. The system as set forth in claim 27 wherein said plurality of first indentations on said main wheel and said plurality of second indentations on said at least one secondary wheel engage one another for creating a ready-to-eat grain based product having a pillow-shape.

30. The cooking system as set forth in claim 26 wherein said secondary wheel includes a plurality of raised portions extending from said second outer face, said plurality of raised portions corresponding to said plurality of first indentations disposed on said main wheel.

31. The system as set forth in claim 30 wherein said plurality of first indentations on said main wheel and said plurality of raised portions on said secondary wheel engage one another for creating a ready-to-eat grain based product having a cup-shape.

32. The cooking system as set forth in claim 21 wherein each of said main wheel and said secondary wheel rotate to maintain the position of said first outer face of said main wheel relative to said second outer face of said at least one secondary wheel.

33. The cooking system as set forth in claim 21 wherein said main wheel and said secondary wheel rotate in opposite directions for moving the grain based material.

34. The system as set forth in claim 21 wherein at least one of said first surface of said main wheel and said second surface of said secondary wheel define a cutting pattern for applying a plurality of intermediate portions to the grain based product to allow for the grain based product to be broken along the intermediate portions.

35. The cooking system as set forth in claim 21 further including a distributor for distributing a product additive on to the grain based product.

36. The cooking system as set forth in claim 35 wherein said product additive is at least one of nuts, fruits, frosting, vitamins, edible particulates, flavorings, and coloring.

37. The cooking system as set forth in claim 35 wherein said product additive is an edible marking applied to the grain based product by at least one of laser marking and ink jetting.

38. The cooking system as set forth in claim 21 further including a plurality of feeders for feeding a grain based material to at least one of said main wheel and said secondary wheel.

39. The cooking system as set forth in claim 21 further including a transfer device disposed beneath said main wheel and said secondary wheel for receiving the grain based product formed between said main wheel and said secondary wheel and moving the grain based product away from said main wheel and said secondary wheel.
